(19) United States
(12) Patent Application Publication
(10) Pub. No.: US 2004/0165560 A1
(43) Pub. Date: Aug. 26, 2004

(54) Method and apparatus for predicting a frame type

(76) Inventors: John M. Harris, Chicago, IL (US); Robert D. Battin, Kildeer, IL (US); Hao Bi, Wheeling, IL (US)

Correspondence Address: MOTOROLA, INC., 1303 EAST ALGONQUIN ROAD, IL01/3RD, SCHAUMBURG, IL, 60196

(21) Appl. No.: 10/373,387

(22) Filed: Feb. 24, 2003

(51) Int. Cl. H04J 3/00

(52) U.S. Cl. 370/336

(57) ABSTRACT

A receiver (201) receives uplink transmissions (104) and passes the last N received frames (f₁, f₂, . . . , f_{N}). The last N frames are analyzed and vector B=(b(f₁), b(f₂), . . . , b(f_{N})), is created. A dot product of B with all possible values of B (B₁, B₂, . . . , B₉) is performed, and the transmission pattern from the last N frames is determined based on the dot product. Once the actual transmission pattern is known, the next received frame type is predicted. If the next frame (N+1) is predicted to be a DTX frame, then a threshold is adjusted to make the DTX_VS_ERASED threshold comparison more likely to conclude that frame N+1 was a DTX. Similarly, if the next frame is predicted to be a voice frame, then the threshold is adjusted to make the DTX_VS_ERASED threshold comparison more likely to conclude that the frame was voice frame.

### REFERENCE(S) TO RELATED APPLICATION(S)

This application is related to a co-pending application Ser. No. 10/295,123, entitled “METHOD AND APPARATUS FOR TRANSMITTING VOICE INFORMATION,” filed Nov. 15, 2002, which is assigned to the assignee of the present application and claims priority from provisional application, Serial No. 60/346,966, entitled “METHOD AND APPARATUS FOR TRANSMITTING VOICE INFORMATION,” filed Nov. 19, 2001. This application is also related to a co-pending application Ser. No. 10/232,061, entitled “COMMUNICATION DEVICE AND METHOD FOR FRAME RECONSTRUCTION AMONG SOFT HANDOFF LEGS,” filed Aug. 30, 2002, which is assigned to the assignee of the present application. This application is also related to a co-pending application Ser. No. 09/524,066, entitled “METHOD AND APPARATUS FOR CHECKING COMMUNICATED DATA,” filed Mar. 13, 2000, which is assigned to the assignee of the present application.

### FIELD OF THE INVENTION

The present invention relates generally to communication systems and in particular, to a method and apparatus for predicting a frame type in such communication systems.

### BACKGROUND OF THE INVENTION

Within a communication system, transmissions are conducted between a transmitting device and a receiving device over a communication resource, commonly referred to as a communication channel. During typical transmission, the transmitting device will not transmit 100% of the time, but instead will transmit information in a periodic fashion. For example, in a system employing a Code Division Multiple Access 2000 (CDMA 2000) protocol, there are two types of traffic channels, a Fundamental Channel (FCH) and a Dedicated Control Channel (DCCH). When there is no data to send, an eighth rate frame and power control is sent if the channel is an FCH. If the channel is a DCCH, then nothing is sent.

Two voice encoders (vocoders) are typically utilized for FCH transmission of voice data, namely I6 and I12 vocoders. (More information on I6 and I12 vocoding can be found in VSELP 4200 BPS Voice Coding Algorithm for iDEN and iDEN RF Interface: Layer 2, both available from Motorola, Inc). During transmission utilizing an I12 vocoding protocol, a transmitter will transmit a voice frame (V) followed by an ⅛^{th} rate frame (D). The pattern is repeated periodically. Typical transmission schemes for I6 and I12 are illustrated in Table 1, where V represents frames that contain voice information and D represents an ⅛^{th} rate frame (e.g., no voice information).

TABLE 1
Transmission Schemes for I6 and I12 vocoders

| | Transmission Pattern for 9 frames, then |
|---|---|
| Vocoder Scheme | repeated. |
| I6 | VVDVVDVVD or |
| | VVVDDVVVD |
| I12 | VDVDVDVDD |

A communication system employing I6 or I12 vocoding is shown in FIG. 1. As shown, remote or mobile unit (MU) 101 transmits a predetermined frame pattern (e.g., VDVDVDVDD) via uplink communication signal 104. Radio Access Network (RAN) 103 receives the uplink frames and transmits them to mobile unit 102 via downlink communication signal 105. In this manner communication takes place between mobile unit 101 and mobile unit 102.

A problem exists in current communication systems in that RAN 103 confuses erased voice frames and ⅛^{th} rate frames (sometimes referred to as DTX frames) a significant percentage of the time. More particularly, poor-quality voice frames are often confused with DTX frames, and vice versa. Confusing erased voice frames and DTX frames results in a negative Radio Frequency (RF) impact as well as degraded voice quality. In particular, RF impact is degraded when DTX frames are mistakenly identified as voice frame erasures and sent over a second radio link as done in mobile to mobile calls like Dispatch. Additionally, this results in an artificially high power control set point that results from DTX frames being misclassified as erasures. Voice quality is also degraded, when erased voice frames are mis-classified as DTX frames and are not forwarded to the listener. These erased voice frames contain important voice information, that is needed by the listener in order to provide the best possible voice quality. Therefore, a need exists for method and apparatus for predicting a frame type in a communication system that eliminates the above-mentioned problems.

### BRIEF DESCRIPTION OF THE DRAWINGS

FIG. 1 is a block diagram of a communication system employing I6 or I12 vocoding.

FIG. 2 is a block diagram of a RAN in accordance with the preferred embodiment of the present invention.

FIG. 3 is a flow chart showing operation of the RAN of FIG. 2 in accordance with the preferred embodiment of the present invention.

### DETAILED DESCRIPTION OF THE DRAWINGS

To address the above-mentioned need a method and apparatus for predicting a frame type is provided herein. A receiver receives uplink transmissions and passes the last N received frames (f₁, f₂, . . . , f_{N}). The last N frames are analyzed and vector B=(b(f₁), b(f₂), . . . , b(f_{N})), is created. A dot product of B with all possible values of B (B₁, B₂, . . . , B₉) is performed, and the transmission pattern from the last N frames is determined based on the dot product. Once the actual transmission pattern is known, the next received frame type is predicted. If the next frame (N+1) is predicted to be a DTX frame, then a threshold is adjusted to make the DTX_VS_ERASED threshold comparison more likely to conclude that frame N+1 was a DTX. Similarly, if the next frame is predicted to be a voice frame, then the threshold is adjusted to make the DTX_VS_ERASED threshold comparison more likely to conclude that the frame was voice frame.

By adjusting the voice/erased frame threshold as described above, the probability that the RAN will confuse erased voice frames and DTX frames is reduced. Because of this, RF impact is improved and situations resulting in an artificially high power control set point that results from DTX frames being misclassified as erasures are eliminated.

The present invention encompasses a method of predicting a frame pattern from a plurality of frame patterns transmitted within a communication system. The method comprises the steps of receiving a plurality of frames, creating a first vector based on the plurality of frames, creating a plurality of vectors based on possible frame patterns, and performing a dot product of the first vector with the plurality of vectors. The frame pattern is predicted based on the dot product.

The present invention additionally encompasses a method of predicting a frame pattern from a plurality of possible frame patterns in a communication system. The method comprising the steps of receiving a plurality of frames (f₁, f₂, . . . , f_{N}), each frame being either a voice/data frame (V) or an ⅛^{th} rate/DTX frame (D). A vector B=(b(f₁), b(f₂), . . . , b(f_{N})) is created of length N, where b(fₓ)=−1 when the frame fₓ is categorized as an ⅛^{th} rate/DTX frame, or b(fₓ)=1 when the frame fₓ is categorized as a voice or data frame. A plurality of vectors is created based on possible frame patterns (B₁, B₂, . . . , B_{N}) and a plurality of dot products is performed of B with B₁, B₂, . . . , B_{N}. Finally, the frame pattern is predicted based on the dot product.

The present invention additionally encompasses an apparatus comprising means for receiving a plurality of frames, means for creating a first vector based on the plurality of frames, means for creating a plurality of vectors based on possible frame patterns, means for performing a dot product of the first vector with the plurality of vectors, and means for predicting the frame pattern based on the dot product.

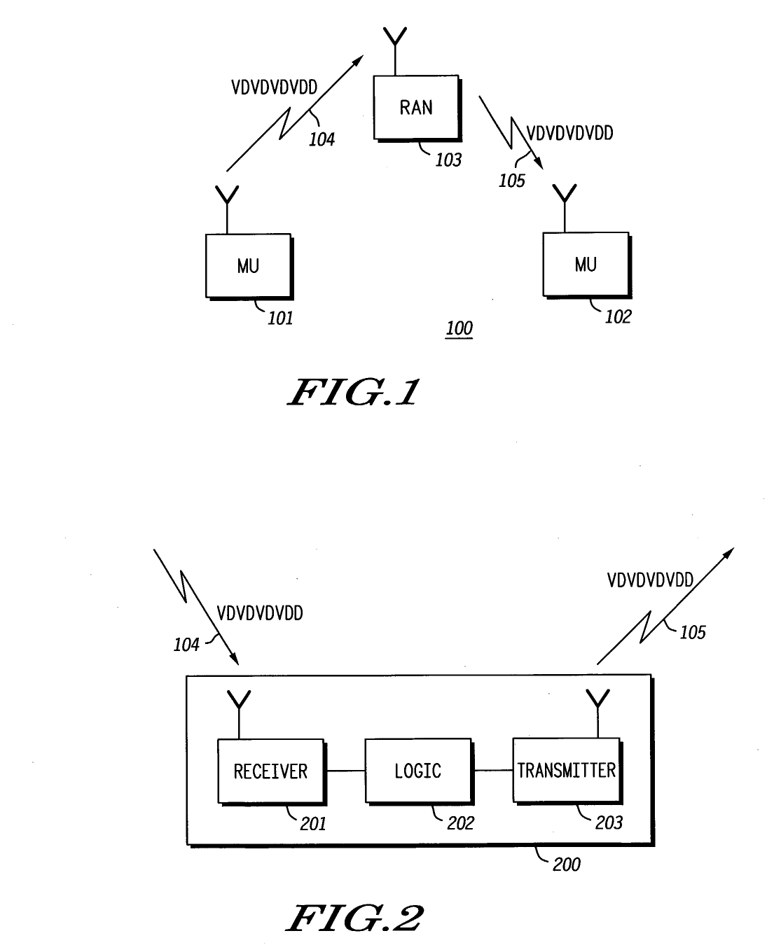

Turning now to the drawings, wherein like numerals designate like components, FIG. 2 is a block diagram of a RAN 200 in accordance with the preferred embodiment of the present invention. In the preferred embodiment of the present invention, RAN 200 utilizes a Code Division Multiple Access (CDMA) system protocol as described in Cellular System Remote unit-Base Station Compatibility Standard of the Electronic Industry Association/Telecommunications Industry Association Interim Standard 2000 (IS2000), which is incorporated by reference herein. (EIA/TIA can be contacted at 2001 Pennsylvania Ave. NW Washington D.C. 20006). In alternate embodiments communication system 100 may utilize other cellular communication system protocols such as but not limited to the Global System for Mobile Communications (GSM) protocol, IS-136, IS-95, or IS-833.

As shown RAN 200 comprises receiver 201 and transmitter 203, which in the preferred embodiment of the present invention are a receiver and transmitter of a Base Transceiver Station (BTS). RAN 200 also comprises logic unit 202. Although not shown, one of ordinary skill in the art will recognize that RAN 200 comprises those elements necessary (e.g., Mobile Switching Stations, Centralized Base Station Controllers, . . . , etc.) necessary for wireless communication. It is contemplated that network elements within RAN 200 are configured in well known manners with processors, memories, instruction sets, and the like, which function in any suitable manner to perform the function set forth herein. Additionally, the description that follows describes determining when a frame is a DTX or a voice frame on a voice channel, or FCH, however one of ordinary skill in the art will recognize that the same procedure may be utilized to determine when a frame is a data frame or a DTX frame transmitted over an FCCH.

Operation of RAN 200 in accordance with the preferred embodiment of the present invention occurs as follows: A predetermined frame pattern is transmitted by a mobile unit (e.g., MU 101). As shown, the predetermined frame pattern is received via receiver 201 as an over-the-air transmission on uplink communication signal 104. Additionally, as shown, the predetermined frame pattern comprises a plurality of voice frames (V) and a plurality of DTX frames (D) (i.e., frames no voice is transmitted). Although the frame pattern shown comprises that for I12 transmission (e.g., VDVDVDVDD), one of ordinary skill in the art will recognize that any frame pattern may be received. The frame pattern periodically repeats every N frames, where in the preferred embodiment of the present invention N=9.

Receiver 201 receives the uplink transmission and passes the last N received frames (f₁, f₂, . . . , f_{N}) to logic unit 202. Logic unit 202 creates a vector

B=(b(f₁), b(f₂), . . . , b(f_{N})), of length N,

Where,

b(fₓ)=−1 when the frame fₓ is categorized as a DTX frame,

b(fₓ)=1 when the frame fₓ is categorized as a voice or data frame.

As discussed above, there exists many instances when a voice or data frame is mistakenly categorized as a DTX frame, and vice versa. For example, a group of 9 frames originally transmitted as VDVDVDVDD might actually be mistakenly categorized as VDDDVDVDD, and thus B=(1,−1,−1,−1,1,−1,1,−1,−1). The perfect reception of the group of 9 frames would result in B=(1,−1,1,−1,1,−1,1,−1,−1).

Once logic unit 202 creates vector B, logic unit 202 analyzes B and determines a number of consecutive DTX frames. In other words, logic unit determines a number of consecutive frames having −1 as a frame value (b(fₓ)). If the number of consecutive DTX frames received exceeds a threshold (e.g., 8), then logic unit 202 assumes the speaker has transitioned to listening state and the frames identified as DTX frames are assumed to be true DTX frames. (It should be noted that in actuality the threshold would be likely double or triple the longest series of DTX within the expected pattern).

If logic unit 202 analyzes B and determines that a number of consecutive frames having −1 as a frame value does not exceed a threshold, then it is assumed that the user is not in a listening mode and logic unit 202 determines the actual transmission pattern (i.e., frame pattern under perfect channel conditions) for the last N frames via the following procedure:

In actuality for any given vocoder transmission pattern there exists a finite possible values for B under perfect channel conditions (i.e., no mistaking V and D frames). More particularly, given an N-frame repeat pattern, there exists N possible values for B under perfect channel conditions. Thus, for I12 (N=9) there exists 9 possible values (B₁, B₂, . . . , B₉) for B illustrated in Table 2.

TABLE 2
Possible values for B under perfect channel conditions

| Received Frame | |
|---|---|
| Pattern for last N frames | B |
| VDVDVDVDD | B₁ = 1, −1, 1, −1, 1, −1, 1, −1, −1 |
| DVDVDVDDV | B₂ = −1, 1, −1, 1, −1, 1, −1, −1, 1 |
| VDVDVDDVD | B₃ = 1, −1, 1, −1, 1, −1, −1, 1, −1 |
| DVDVDDVDV | B₄ = −1, 1, −1, 1, −1, −1, 1, −1, 1 |
| VDVDDVDVD | B₅ = 1, −1, 1, −1, −1, 1, −1, 1, −1 |
| DVDDVDVDV | B₆ = −1, 1, −1, −1, 1, −1, 1, −1, 1 |
| VDDVDVDVD | B₇ = 1, −1, −1, 1, −1, 1, −1, 1, −1 |
| DDVDVDVDV | B₈ = −1, −1, 1, −1, 1, −1, 1, −1, 1 |
| DVDVDVDVD | B₉ = −1, 1, −1, 1, −1, 1, −1, 1, −1 |

Logic unit 202 performs a dot product of B with all possible outcomes of B under perfect channel conditions (i.e., dot product of B with B₁, B₂, . . . , B_{N}). The product that results in the largest value represents the received frame pattern. For example, if B=(1,−1,−1,−1,1,−1,1,−1,−1) (corresponding to a received frame pattern of VDDDVDVDD) then:

B B₁=(1,−1,−1,−1,1,−1,1,−1,−1)(1,−1,1,−1,1,−1,1,−1,−1)=1+1−1+1+1+1+1+1+1=7

B B₂=(1,−1,−1,−1,1,−1,1,−1,−1)(−1,1,−1,1,−1,1,−1,−1,1)=−5

B B₃=(1,−1,−1,−1,1,−1,1,−1,−1)(1,−1,1,−1,1,−1,−1,1,−1)=3

B B₄=(1,−1,−1,−1,1,−1,1,−1,−1)(−1,1,−1,1,−1,−1,1,−1,1)=−1

B B₅=(1,−1,−1,−1,1,−1,1,−1,−1)(1,−1,1,−1,−1,1,−1,1,−1)=−1

B B₆=(1,−1,−1,−1,1,−1,1,−1,−1)(−1,1,−1,−1,1,−1,1,−1,1)=3

B B₇=(1,−1,−1,−1,1,−1,1,−1,−1)(1,−1,−1,1,−1,1,−1,1,−1)=1

B B₈=(1,−1,−1,−1,1,−1,1,−1,−1)(−1,−1,1,−1,1,−1,1,−1,1)=3

B B₉=(1,−1,−1,−1,1,−1,1,−1,−1)(−1,1,−1,1,−1,1,−1,1,−1)=−5

The transmission scheme chosen is the one that results in the largest dot product greater than the threshold.

In certain situations there can exist more than one dot product greater than the threshold, each having an equal value. In this situation, if any of the patterns (B₁-B₉) predict that the next frame is a Voice frame, then that pattern is chosen as the transmission pattern for the last N frames.

The above procedure helps determine which of the N transmission patterns have been transmitted during the last N frames. Once the transmission pattern for the last N frames has been determined, logic unit 202 uses this information to help predict the next frame received by the mobile unit. In other words, RAN 200 utilizes the predicted frame pattern transmitted over the last N frames to help make a decision on the status of the next frame received. For example, during I12 transmission (VDVDVDVDD), if a frame pattern of DDVDVDVDV was determined for the last N frames received, then there is a very high probability that the next frame received would be a D frame. Logic unit 202 uses this information to adjust a threshold (DTX_VS_ERASED for CDMA 2000) used to identify DTX frames. More particularly, if the next frame (N+1) is predicted to be a DTX frame, then the threshold is adjusted to make the DTX_VS_ERASED threshold comparison more likely to conclude that the frame was a DTX. Similarly, if the next frame is predicted to be a voice frame, then the threshold is adjusted to make the DTX_VS_ERASED threshold comparison more likely to conclude that the frame was a voice frame.

By adjusting the voice/erased frame threshold as described above, the probability that the RAN will confuse erased voice frames and DTX frames is reduced. Because of this, RF impact is improved and situations resulting in an artificially high power control set point that results from DTX frames being misclassified as erasures are eliminated.

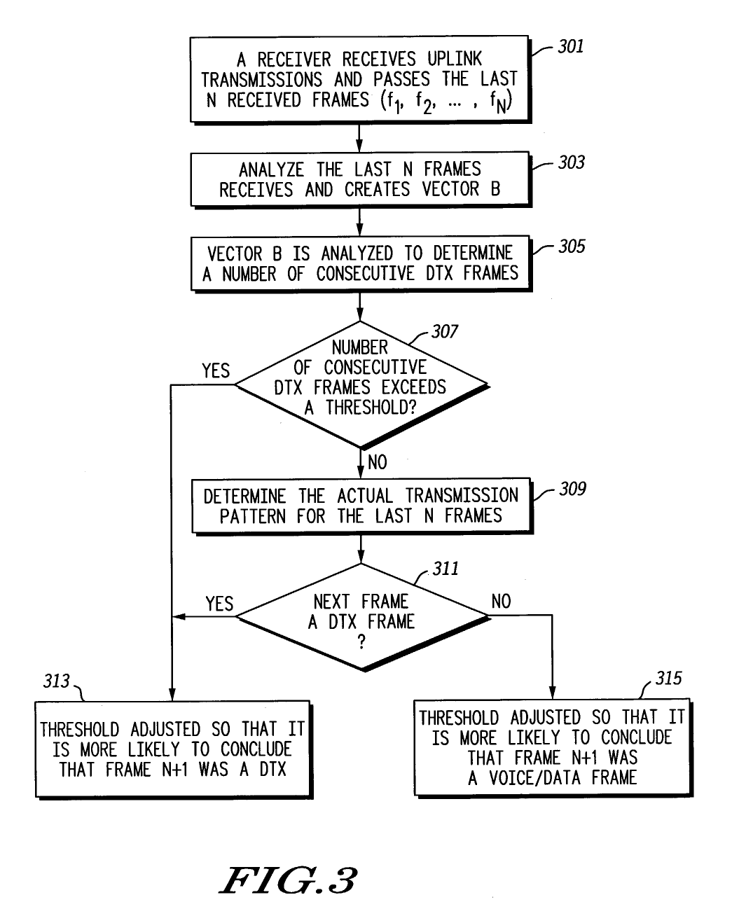

FIG. 3 is a flow chart showing operation of the RAN of FIG. 2 in accordance with the preferred embodiment of the present invention. The logic flow starts at step 301 where a receiver receives uplink transmissions and passes the last N received frames (f₁, f₂, . . . , f_{N}) to logic unit 202. Logic unit 202 analyzes the last N frames received and creates vector B=(b(f₁), b(f₂), . . . , b(f_{N})), of length N (step 303). At step 305 vector B is analyzed to determine a number of consecutive DTX frames (i.e., frames having −1 as a frame value). At step 307 logic unit determines if the number of consecutive DTX frames exceeds a threshold, and if so the DTX frames are assumed to be true DTX frames and the logic flow continues to step 313, otherwise the logic flow continues to step 309.

At step 309 logic unit 202 determines the actual transmission pattern for the last N frames. As discussed above, this involves the dot product of B with all possible values of B (B₁, B₂, . . . , B₉) illustrated in Table 2. Once the actual transmission pattern is known, the next received frame type is predicted. In other words, logic unit 202 predicts whether the next frame is a voice/data frame or an 8^{th} rate/DTX frame. Thus, at step 311 it is determined if the next frame (frame N+1) is a DTX frame, and if so, the logic flow continues to step 313, otherwise the logic flow continues to step 315.

If the next frame (N+1) is predicted to be a DTX frame, then a threshold is adjusted (step 313) to make the DTX_VS_ERASED threshold comparison more likely to conclude that frame N+1 was a DTX. Similarly, if the next frame is predicted to be a voice frame, then the threshold is adjusted (step 315) to make the DTX_VS_ERASED threshold comparison more likely to conclude that the frame was a voice frame.

For DCCH reception, a frame is decoded after despreading and demodulation. A number of metrics are generated from the decoder to indicate the quality of decoding process. Examples of these metrics are Total Metric, Yamamoto bit, symbol error count, and frame energy. These metrics are used to facilitate the detection of DTX frame. Specifically, a composite metric is constructed from these metrics, and compared with an appropriate threshold (DTX_VS_ERASED). If it is lower than the threshold, then this is a DTX frame; otherwise a frame (data) is indeed transmitted. The composite metric is (1−Pdtx_TM)*(1−Pdtx_Yb)*(1−Pdtx_SER)*(1−Pdtx_FE), where Pdtx_TM, Pdtx_Yb, Pdtx_SER, and Pdtx_FE are the DTX probabilities based on Total Metric, Yamamoto bit, symbol error count, and frame energy, respectively. After the frame is determined non-DTX, it is checked against O-CRC. If the check passes, the frame is good; if the O-CRC check fails, the frame is labeled as an erasure.

With the knowledge from vocoder frame pattern, the composite metric is further refined to be: (1−Pdtx_TM)*(1−Pdtx_Yb)*(1−Pdtx_SER)*(1−Pdtx_FE)*(1-Pdtx_PAT), where Pdtx_PAT is the DTX probability from pattern matching. Pdtx_PAT is set to some value greater than 0.5 and less than 1, if the next frame is predicted to be a DTX frame. For example, 0.75. Pdtx_PAT is set to some value greater than 0 and less than 0.5, if the next frame is predicted to be a DTX frame. For example, 0.25.

For FCH reception, the process is a little different. In this case, every frame that is received is either a full, half, quarter or eighth rate (DTX) frame. The convolution decoder decodes the received symbols into these four candidate sets, with different sets of those metrics generated for each case. Then a CRC check is applied to these candidate sets and the frame rate is determined as the candidate who passes the check. If none of the four candidate passes the check, the frame is labeled as an erasure. The sets of decoder metrics can then be used to determine the most likely rate for the erasure frame.

The composite metric is (1−Pdtx_TM)*(1−Pdtx_Yb)*(1−Pdtx_SER)*(1−Pdtx_FE), where Pdtx_TM, Pdtx_Yb, Pdtx_SER, and Pdtx_FE are the DTX probabilities based on Total Metric, Yamamoto bit, symbol error count, and frame energy, respectively. For example, if the above composite metric is used, the frame rate can be determined as the candidate having the largest composite metric, however, the reliability of the detection is usually low with erasure frame. The knowledge of vocoder pattern can help improving the detection accuracy.

Let the Pfull denote the probability of full frame from pattern matching, then the probability of eighth rate (DTX) would be (1-Pfull) in dispatch service. Pfull is set to some value greater than 0.5 and less than 1, if the next frame is predicted to be a voice frame. For example, 0.75. Pfull is set to some value less than 0.5 and greater than 0, if the next frame is predicted to be a non-voice frame. For example, 0.25. Pfull and (1-Pfull) are then multiplied with composite metrics of full rate and eighth rate respectively, and the largest product is then taken to indicate the rate of the erased frame.

In the preferred embodiment of the present invention it is the DTX_VS_ERASED threshold that is varied based on a predicted next frame type, however, in alternate embodiments of the present invention any threshold utilized to predict a frame type may be varied. For example, on the DCCH, a frame is decoded after despreading and demodulation. A number of metrics can be generated from the decoder to indicate the quality of decoding process. Examples of these metrics are Total Metric, Yamamoto bit, symbol error count, and frame energy. These metrics can be used to facilitate the detection of DTX frame. For example, a composite metric can be constructed from these metrics, and compared with an appropriate threshold. If it is lower than the threshold, then this is a DTX frame; otherwise a frame is indeed transmitted. After the frame is determined non-DTX, it can be checked against O-CRC. If the check passes, the frame is good; if the O-CRC check fails, the frame is labeled as an erasure.

While the invention has been particularly shown and described with reference to a particular embodiment, it will be understood by those skilled in the art that various changes in from and details may be made therein without departing from the spirit and scope of the invention. For example, although the preferred embodiment performs a dot product of the last N frames received with all possible frame patterns, any mathematical operation that compares the last N frames with all possible frame patterns may be performed, as long as such an operation yields a result that predicts the frame pattern. It is intended that such changes come within the scope of the following claims.

1. A method of predicting a frame pattern from a plurality of frame patterns transmitted within a communication system, the method comprising the steps of:
receiving a plurality of frames;
creating a first vector based on the plurality of frames;
creating a plurality of vectors based on possible frame patterns;
performing a dot product of the first vector with the plurality of vectors; and
predicting the frame pattern based on the dot product.

2. The method of claim 1 further comprising the step of predicting a next frame type based on the predicted frame pattern.

3. The method of claim 2 further comprising the steps of:
predicting a next frame type based on the predicted frame pattern; and
adjusting a second threshold so that a receiver is more likely to conclude that the next frame type is a DTX frame based on the predicted next frame type.

4. The method of claim 2 further comprising the steps of:
predicting a next frame type based on the predicted frame pattern; and
adjusting a second threshold so that a receiver is more likely to conclude that the next frame type is a voice/data frame based on the predicted next frame type.

5. The method of claim 1 wherein the step of receiving the plurality of frames comprises the step of receiving the plurality of frames (f₁, f₂, . . . , f_{N}), each frame being either a voice/data frame (V) or an ⅛^{th} rate/DTX frame (D).

6. The method of claim 5 wherein the step of creating the first vector comprises the step of creating a vector B=(b(f₁), b(f₂), . . . , b(f_{N})), of length N, wherein b(fₓ)=−1 when the frame fₓ is categorized as an ⅛^{th} rate/DTX frame, or b(fₓ)=1 when the frame fₓ is categorized as a voice or data frame.

7. The method of claim 1 wherein the step of predicting the frame pattern based on the dot product comprises the step of determining the frame pattern resulting in a largest dot product greater than a threshold.

8. A method of predicting a frame pattern from a plurality of possible frame patterns in a communication system, the method comprising the steps of:
receiving a plurality of frames (f₁, f₂, . . . , f_{N}), each frame being either a voice/data frame (V) or an ⅛^{th} rate/DTX frame (D);
creating a vector B=(b(f₁), b(f₂), . . . , b(f_{N})), of length N, wherein b(fₓ)=−1 when the frame fₓ is categorized as an ⅛^{th} rate/DTX frame, or b(fₓ)=1 when the frame fₓ is categorized as a voice or data frame;
creating a plurality of vectors based on possible frame patterns (B₁, B₂, . . . , B_{N});
performing a plurality of dot products of B with B₁, B₂, . . . , B_{N}; and
predicting the frame pattern based on the dot product.

9. The method of claim 8 further comprising the step of predicting a next frame type based on the predicted frame pattern.

10. The method of claim 9 wherein the step of predicting the frame pattern based on the dot product comprises the step of determining the frame pattern resulting in a largest dot product greater than a threshold.

11. The method of claim 8 further comprising the steps of:
predicting a next frame type based on the predicted frame pattern; and
adjusting a second threshold so that a receiver is more likely to conclude that the next frame type is a DTX frame based on the predicted next frame type.

12. The method of claim 8 further comprising the steps of:
predicting a next frame type based on the predicted frame pattern; and
adjusting a second threshold so that a receiver is more likely to conclude that the next frame type is a voice/data frame based on the predicted next frame type.

13. An apparatus comprising:
means for receiving a plurality of frames;
means for creating a first vector based on the plurality of frames;
means for creating a plurality of vectors based on possible frame patterns;
means for performing a dot product of the first vector with the plurality of vectors; and
means for predicting the frame pattern based on the dot product.

14. The apparatus of claim 13 further comprising means for predicting a next frame type based on the predicted frame pattern.

15. The apparatus of claim 13 wherein the means for predicting the frame pattern based on the dot product comprises means for determining the frame pattern resulting in a largest dot product greater than a threshold.

16. The apparatus of claim 13 wherein the means for receiving the plurality of frames comprises means for receiving the plurality of frames (f₁, f₂, . . . , f_{N}), each frame being either a voice/data frame (V) or an ⅛^{th} rate/DTX frame (D).

17. The apparatus of claim 16 wherein the means for creating the first vector comprises means for creating a vector B=(b(f₁), b(f₂), . . . , b(f_{N})), of length N, wherein b(fₓ)=−1 when the frame fₓ is categorized as an ⅛^{th} rate/DTX frame, or b(fₓ)=1 when the frame fₓ is categorized as a voice or data frame.

18. The apparatus of claim 16 further comprising:
means for predicting a next frame type based on the predicted frame pattern; and
means for adjusting a second threshold so that a receiver is more likely to conclude that the next frame type is a DTX frame based on the predicted next frame type.

19. The apparatus of claim 16 further comprising:
means for predicting a next frame type based on the predicted frame pattern; and
means for adjusting a second threshold so that a receiver is more likely to conclude that the next frame type is a voice/data frame based on the predicted next frame type.
